(19) United States
(12) Patent Application Publication
(10) Pub. No.: US 2011/0095905 A1
(43) Pub. Date: Apr. 28, 2011

(54) In-vehicle data communication device and method for communicating with external resource center

(75) Inventor: Kenji Mase, Chita-gun (JP)

(73) Assignee: DENSO CORPORATION, Kariya-city (JP)

(21) Appl. No.: 12/923,314

(22) Filed: Sep. 14, 2010

(30) Foreign Application Priority Data
Oct. 22, 2009 (JP) 2009-243415

(51) Int. Cl. G08G 1/00

(52) U.S. Cl. 340/901

(57) ABSTRACT

An assigning unit assigns multiple conditions to communication units. A detection unit detects which of the communication units is communicable with an external resource center. When the detection unit detects that multiple communication units are communicable with the external resource center, a selecting unit selects one communication unit according to the multiple conditions assigned by the assigning unit. Thus, an in-vehicle data communication unit obtains data from the external resource center via the selected one communication unit.

### CROSS REFERENCE TO RELATED APPLICATIONS

This application is based on and incorporates herein by reference Japanese Patent Application No. 2009-243415 filed on Oct. 22, 2009.

### FIELD OF THE INVENTION

The present invention relates to an in-vehicle data communication device configured to obtain data from an information center via multiple communication units.

The present invention relates to a method for communicating with an external resource center.

### BACKGROUND OF THE INVENTION

Conventionally, a car navigation device obtains data, such as navigation map data including road map data and facility data, music data, and a firmware of the navigation device, from an information center. Conventionally, such data is loaded in a navigation device using a portable media, such as a CD-ROM and a memory card storing data provided by an information center. For example, publication of Japanese Patent Application 2008-58748 (JP-A-2008-58748), which corresponds to US 2009/0172031 A1, proposes a device configured to use multiple communication units (communication ways) for obtaining data in addition to using a portable recording medium. Such a device uses an in-vehicle communication module and a cell-phone device as a communication infrastructure. JP-A-2008-58748 proposes an art of arbitration when multiple communication units obtain updating data for a navigation map and when a conflict occurs in acquisition timing of the multiple communication units. Specifically, when data. is obtained from a portable medium and simultaneously when a cell-phone device or a communication module obtains new data, a priority is given to the former. Further, a priority is given to one of the cell-phone device and the communication module, which has been operating earlier than the other, and data acquisition is continued.

In-recent years, latest communication units other than a portable medium are increasing in variety and different in characteristics. For example, communication ways may by exemplified by the wireless fidelity (Wi-Fi, registered trademark), the worldwide interoperability for microwave access (WiMAX, registered trademark), the 1XWIN (registered trademark), the high speed downlink packet access (HSDPA), the personal handyphone system (PHS), the power line communication (PLC), a home wireless LAN, and the like. The Wi-Fi represents an interconnection between wireless. LAN devices via the IEEE 802.11 wireless communication standard such as IEEE 802.11a or IEEE 802.11b. The IEEE represents the institute of electrical and electronic engineers. The Wi-Fi is certified by the Wi-Fi alliance, which is an industry group having a headquarters in the United States. The WiMAX represents the high-speed wireless Internet for wireless LAN devices standardized based on the IEEE 802.16e. Dissimilarly to the wireless LAN used in a local spot in a specific place, the WiMAX enables high-speed communications in a wide area. The 1XWIN is a communication way for high-speed data communications used in a cell phone service of a certain manufacturer. The HSDPA is a communication way for high-speed data communications used in a cell phone service of another manufacturer. The PHS is one kind of cell phone systems having a simplified facility and simplified configuration to enable a low communication cost. One base station of a PHS system covers a narrow range, and one PHS terminal has a wider frequency band than that of a cellular phone terminal. Therefore, a PHS system enables high-speed data communications of 32k bps to 64k bps and is excellent in communication speed compared with a cellular phone system. Many infrastructures of PHS systems are available in city areas. The PLC is a general term representing high-speed power line communications. The PLC is an art to use conventional electricity supply wirings (power lines) as data exchange wirings for the Internet. The home wireless LAN is a generally known wireless network for multiple computers to share the Internet access, a printer device, data files, and the like.

An in-vehicle device can obtain various information (data) via these communication ways. Nevertheless, there are problems in use of such communication ways. Specifically, when the vehicle moves from a city to a suburban area, data communication may be frequently interrupted due to less availability of communication infrastructures. Alternatively, an in-vehicle, communication device may use a low-speed communication way, even when the in-vehicle communication device can use a high-speed communication way in the present area of the vehicle. Alternatively, an in-vehicle communication device may use a charged (paid) communication way even when the in-vehicle communication device can use a free communication way such as a home wireless LAN or a public wireless LAN. JP-A-2008-58748 may teach an art of giving a priority to multiple communication ways or portable storage media. Specifically, in JP-A-2008-58748, when data is being obtained via one communication way or from one portable storage medium and when data acquisition is further started via another communication way or from another portable storage medium, a priority is given to the one or the other communication way or medium. Nevertheless, JPA-2008-58748 does not teach giving a priority to multiple communication ways in consideration of a self-vehicle position area, a communication cost, and the like.

### SUMMARY OF THE INVENTION

In view of the foregoing and other problems, it is an object of the present invention to produce an in-vehicle data communication unit configured to select a communication unit (communication way) in consideration of a vehicle position, a communication cost, and a communication speed. It is another object of the present invention to produce a method for communicating with an external resource center.

According to one aspect of the present invention, an in-vehicle data communication unit communicable with an external resource center via a plurality of communication units, the in-vehicle data communication unit configured to select one of the communication units and obtain data from the external resource center via the selected one communication unit, the in-vehicle data communication unit comprises of an assigning unit configured to assign priority conditions to the communication units. The in-vehicle data communication unit further comprises of a detection unit configured to detect which one of the communication units is communicable with the external resource center. The in-vehicle data communication unit further comprises of a selecting unit configured to, when the detection unit detects a plurality of communication units to be communicable with the external resource center, select one communication unit from the communication units detected to be communicable, according to the priority conditions assigned by the assigning unit.

According to another aspect of the present invention, a method for communicating with an external resource center, the method comprises of assigning priority conditions to a plurality of communication units. The method further comprises of detecting which one of the communication units is communicable with the external resource center. The method further comprises of selecting, when the detecting detects a plurality of communication units to be communicable with the external resource center, one communication unit from the communication units detected to be communicable, according to the assigned priority conditions. The method further comprises of obtaining data from the external resource center via the selected one communication unit.

### BRIEF DESCRIPTION OF THE DRAWINGS

The above and other objects, features and advantages of the present invention will become more apparent from the following detailed description made with reference to the accompanying drawings. In the drawings:

FIG. 1 is a block diagram showing an in-vehicle data communication unit according to one embodiment, the in-vehicle data communication unit being combined with a car navigation device;

FIG. 2 is a Nock diagram showing an overview of a data communication system;

FIG. 3 is a flow chart showing a first control of the in-vehicle data communication unit; and

FIG. 4 is a flow chart showing a second control of the in-vehicle data communication unit.

### DETAILED DESCRIPTION OF PREFERRED EMBODIMENTS

(Embodiment)

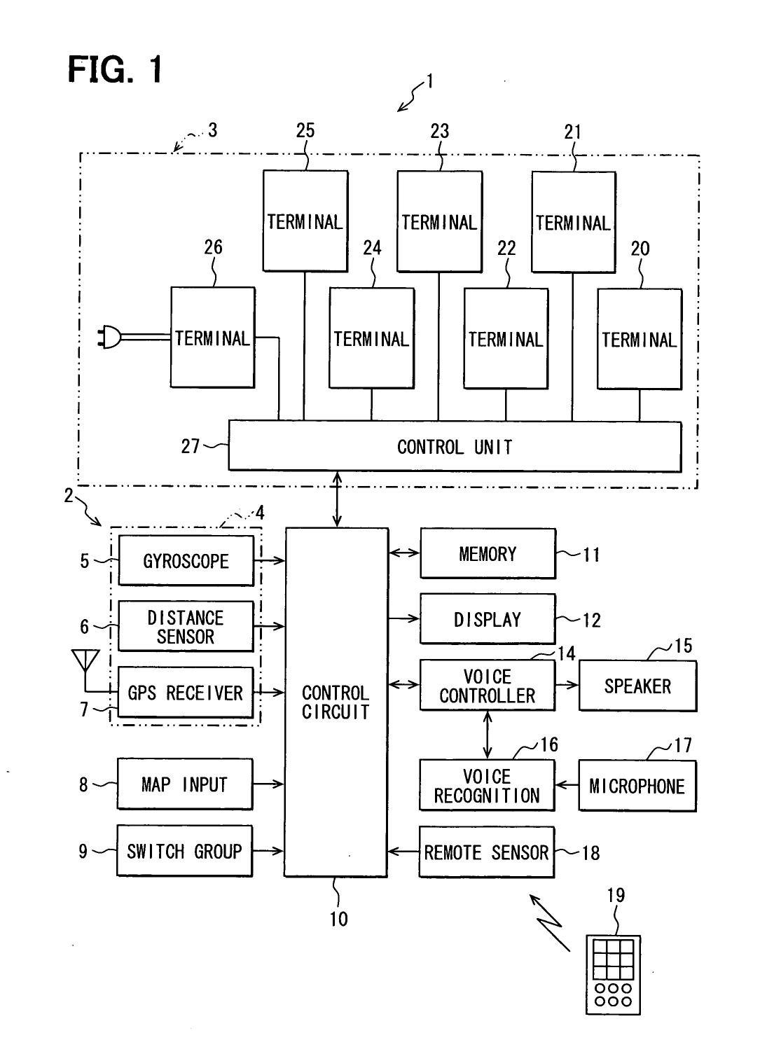

As follows, an embodiment will be described with reference to drawings. FIG. 1 shows an overall structure of an in-vehicle apparatus 1 mounted to an electric vehicle. The in-vehicle apparatus 1 includes a car navigation device 2 and an in-vehicle data communication unit 3 connected to the car navigation device 2.

The in-vehicle navigation device 2 includes a position detecting unit 4, a map data input unit 8, an operation switch group 9, a control unit (determination unit) 10, an external memory 11, a display device 12, a voice controller 14, a speaker 15, a voice recognition unit 16, a microphone 17, a remote controller sensor 18, and a remote controller terminal (remote controller) 19.

The control unit 10 is configured of a general computer configured to inputs various information from the position detecting unit 4, the map data input unit 8, the operation switch group 9, the external memory 11, the display device 12, the voice controller 14, the speaker 15, the voice recognition unit 16, the remote controller sensor 18, and the like. Based on the inputted various information from the devices, the control unit 10 performs various operations such as a route guidance operation, a map scale change operation, a menu indication and selection operation, a destination setting operation, a route searching operation, a route guidance start operation, a current position correction operation, an indicated screen change operation, a volume control operation, a notification control operation, and the like. The control unit 10 further performs communication with an external resource center via the in-vehicle data communication unit 3 so as to perform a map data update operation, a traffic information acquisition operation, a music data acquisition operation, and the like.

The position detecting unit 4 includes a gyroscope 5 and a distance sensor 6. The position detecting unit 4 further includes a GPS receiver 7 for the global positioning system (GPS) to detect the current position of the vehicle based on an electric wave from a satellite. Each sensor 5, 6, 7 has an error caused by difference in character. Therefore, the sensors 5, 6, 7 operate so as to complement each other. In consideration of detection accuracy, the position detecting unit 4 may include a part of the sensors 5, 6, 7, and may additionally include a rotation sensor of a steering wheel, a vehicle speed sensor of each driving rolling wheel, and the like (not shown).

The map data input unit 8 is equipped with a storage-medium (not shown). The map data input unit 8 functions to input various data such as so-called map matching data, map data, landmark data, and the like stored in the storage medium. The map matching data is for enhancing accuracy of position detection. The storage medium is, for example, a CD-ROM, a DVD-ROM, and/or the like.

The operation switch group 9 may include a touch sensor and/or a mechanical switch device integrated with the display device 12, for example. The remote controller 19 includes multiple switch devices. In response to operation of the switch devices of the remote controller 19, various instruction signals are inputted from the remote controller 19 to the control unit 10 through the remote controller sensor 18 thereby causing the control unit 10 to perform various operations. Either of the operation switch group 9 or the remote controller 19 can cause the control unit 10 to perform the same operation by a switch device operation.

The external memory 11 is a large-scale rewritable storage medium such as a hard disk drive (HDD). The external memory 11 is used for storing a large amount of data, for storing data, which should not be erased when power supply is terminated, and for storing frequently used data copied from the map data input unit 8. The display device 12 may be a liquid crystal display device, an organic electroluminescence device, or the like having a full color indication function. The display device 12 is equivalent to a notification unit. The display device 12 functions as a navigation device to indicate a map and a destination select screen and to provide guidance information such as alarming information. Specifically, the display device 12 may provide VICS information and DSSS information, for example.

The speaker 15 is equivalent to a notification unit configured to output a predetermined voice to the outside according to a voice output signal inputted from the voice controller 14. Specifically, the speaker 15 provides a guidance voice, an explanation for screen operation, a voice recognition result, guidance alarming information, and the like. The microphone 17 receives a voice of a user and sends an electric signal of the voice to the voice recognition unit 16. The voice recognition unit 16 compares a voice of a user received by the microphone 17 with lexical data (comparison pattern) in a recognition dictionary (not shown) stored in the voice recognition unit 16 and sends a comparison result, which has the highest in coincidence, as a recognition result to the voice controller 14. The voice controller 14 controls the voice recognition unit 16 and performs a talk-back control (voice output) to a user, who performed voice input, via the speaker 15. The voice controller 14 further sends a recognition result of the voice recognition unit 16 to the control unit 10.

The control unit 10 performs predetermined operations in response to a user's voice according to information sent from the voice recognition unit 16. The predetermined operations include, for example, a map scale change operation, a menu indication and selection operation, a destination setting operation, a route searching operation, a route guidance start operation, a current position correction operation, an indicated screen change operation, a volume control operation, and/or the like. The control unit 10 processes route guidance voice information and the like, and the voice controller 14 arbitrarily notifies a user of processed information via the speaker 15.

The in-vehicle data communication unit 3 includes multiple communication units such as a communication terminal (wireless-communications terminal) 20 for Wi-Fi, a communication terminal (wireless-communication terminal) 21 for WiMAX, a communication terminal (wireless-communication terminal) 22 for 1XWIN, a communication terminal (wireless-communication terminal) 23 for HSDPA, a communication terminal (wireless-communication terminal) 24 for PHS, communication terminal 25 (wireless-communication terminal) for home LAN, a communication terminal 26 (wired-communication terminal) for PLC, and/or the like. The in-vehicle data communication unit 3 need not include all the communication terminals and may arbitrary include a part of the communication terminals or all the communication terminals, as needed.

The in-vehicle data communication unit 3 further includes a communication control unit 27 equivalent to a communication unit assigning unit and communicable unit detection unit (detection unit). The in-vehicle data communication unit 3 is mainly configured of a general computer device. The communication control unit 27 includes a nonvolatile memory as a storage unit (not shown).

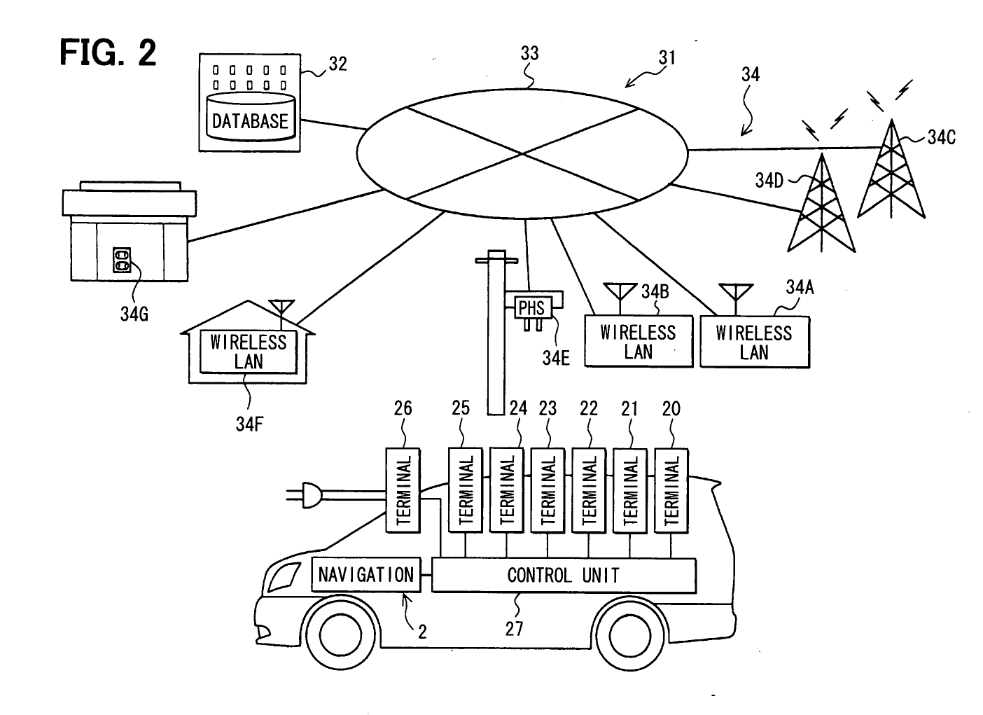

FIG. 2 is a overview showing a data communication system 31. An information center 32 equivalent to a resource center stores a database related to updating data for a map, traffic information, music data, and/or the like. The information center 32 may store multiple kinds of data as a whole. Alternatively, multiple information centers may be provided respectively for multiple kinds of data. The information center 32 provides various data to the in-vehicle apparatus 1 through a wide area network 33, such as the Internet, and various communication infrastructure group 34.

The communication infrastructure group 34 may include a wireless LAN 34A for Wi-Fi, a wireless LAN 34B for WiMAX, a cell-phone network 34C for 1XWIN, a cell-phone network 34D for HSDPA, a public PHS network 34E, a home wireless network 34F, and a PLC 34G. The communication infrastructure group 34 may include another communication infrastructure. It suffices that the communication infrastructure group 34 includes at lest two of the networks (infrastructures).

The communication control unit 27 beforehand stores a priority condition as default information. The priority condition can be changed by a user. The operation switch group 9 and the remote controller 19 of the car navigation device 2 are equivalent to a priority condition assigning unit (assigning unit). The operation switch group 9 and the remote controller 19 also serve as a part of the in-vehicle data communication unit 3. The in-vehicle data communication unit 3 may include the priority condition assigning unit.

Specifically, the display device 12 is caused to indicate multiple priority conditions. A user operates the operation switch group 9 and the remote controller 19 to select one from multiple priority conditions. The priority conditions include a communication cost priority, a communication speed priority, a self-vehicle area priority, a communication stability priority, and/or the like. It suffices that the priority conditions include at least two of these priority conditions.

When the communication cost, priority is selected, one of the communicable units of low communication cost is selected. Specifically, communication cost conditions of the communication terminals (communication units) are compared with each other, and priorities are given to the communication terminals in ascending order. The communication cost conditions are changed depending on a contract. The communication terminals include the communication terminal 20 for Wi-Fi, the communication terminal 21 for WiMAX, the communication terminal 22 for 1XWIN, the communication terminal 23 for HSDPA, the communication terminal 24 for PHS, the communication terminal 25 for home LAN, and the communication terminal 26 for PLC. When the communication speed priority is selected, one of the communication units of high communication speed is selected. Specifically, communication speeds of the communication terminals 20 to 26 are compared, and priorities are given to the communication terminals 20 to 26 in order of the high communication speed.

When the self-vehicle area priority is selected, one of the communicable communication terminals 20 to 26 is selected according to the area of the self-vehicle position. The self-vehicle position may be a stop position of the vehicle or an under-traveling position of the vehicle and includes a home area, a city area, a public-wireless-LAN area, a suburban area, a vehicle battery charge facility area, and/or the like. For example, when the self-vehicle area priority is selected and when the self-vehicle is located in a home area, priority may be given to the communication terminal 25 for a home wireless network, which is free of communication cost.

Alternatively, when the vehicle is in a city area, priority is given (assigned) to the communication terminal 24 for PHS, which is low in the communication cost and high in the communication speed. Alternatively, when the vehicle is in a suburban area, priority is given to communication terminals having wide communication network areas, such as the communication terminal 22 for 1XWIN and the communication terminal 23 for HSDPA.

Alternatively, when the vehicle is in a vehicle battery charge facility area such as a convenience store provided with a vehicle battery charge facility, priority is given to the communication terminal 26 for PLC. The communication terminal 26 for PLC is configured to obtain data simultaneously when receiving electricity supplied from a power receptacle of a vehicle battery charge facility to a vehicle battery of the self-vehicle (electric vehicle). Such a vehicle battery charge facility is provided in a convenience store, a house, and another specific area.

When the communication stability priority is selected, one of the communicable communication terminals 20 to 26 is selected according to stability of communication. Specifically, priority is given to a communication terminal being stable in communication. In this case, when communicable communication terminals include a wired-communication terminal (communication terminal 26 for PHS) and a wireless-communication terminal (communication terminals 20 to 25), a wired-communication terminal is determined to be higher in communication stability. When communicable communication terminals include multiple wireless-communication terminals and no wired-communication terminal, priorities are given to the multiple wireless-communication terminals in order of high communication stability.

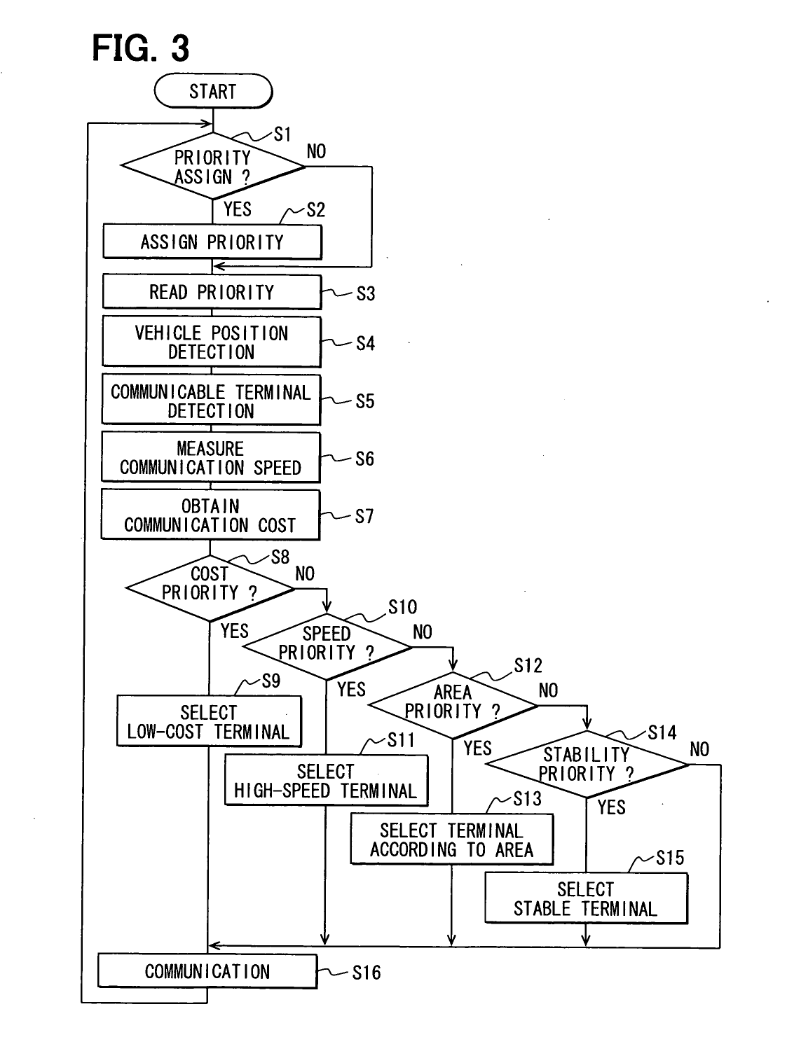

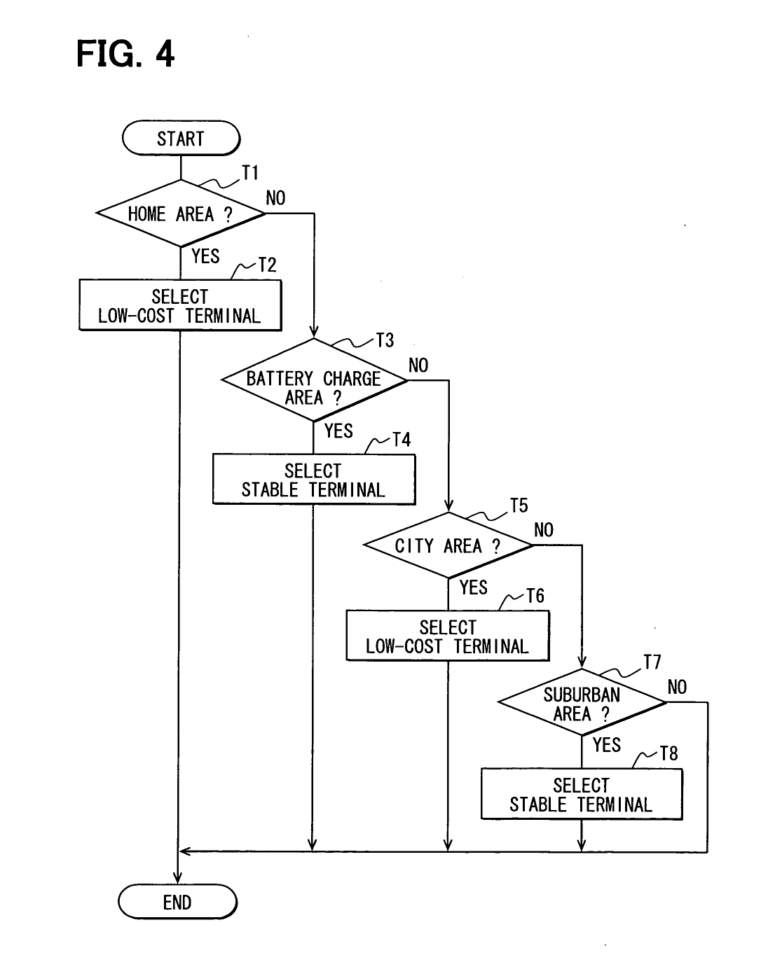

As follows, a control content including functions of a communicable unit detection unit and a communication unit selecting unit of the communication control unit 27 will be described with reference to the flow charts of FIGS. 3 and 4. In FIG. 3, at step S1, it is determined whether an operation is made for assigning a priority condition. When an operation is made for assigning a priority condition, the processing proceeds to step S2 at which a priority condition is assigned according to the operation. When an operation is not made for assigning a priority condition, the processing proceeds to step S3. At step S3, selected one of priority conditions, such as the communication cost priority, the communication speed priority, the self-vehicle area priority, and the communication stability priority, is read.

At subsequent step S4, self-vehicle position information is obtained from the car navigation device 2. At step S5, it is detected which one of the multiple communication terminals 20 to 26 of the self-vehicle is communicable with the external communication infrastructure group 34. In this case, when the self-vehicle is in a vehicle battery charge facility area, it is detected that the communication terminal 26 for PLC is communicable. Further, wireless-communication terminals other than the communication terminal 26 for PLC are sequentially activated, and it is determined whether the activated wireless-communication terminal is communicable to an external resource center. In this case, the other wireless-communication terminals may include the communication terminal 20 for Wi-Fi, the communication terminal 21 for WiMAX, the communication terminal 22 for 1XWIN, the communication terminal 23 for HSDPA, the communication terminal 24 for PHS, and the communication terminal 25 for home LAN. In this , way, a communicable communication terminal is detected.

At step S6, communication speeds of communicable communication terminals are measured. Specifically, a communication test is performed for wireless-communication terminals other than the communication terminal 26 for PLC to measure a communication speed of each wireless-communication terminal. A communication speed of the communication terminal 26 for PLC is known, and the known communication speed is read from a storage device, for example. At subsequent step S7, communication costs of the communicable communication terminals are obtained. The communication costs are beforehand stored in a nonvolatile memory of the communication control unit 27. At subsequent step S8, it is determined whether the selected priority condition is the communication cost priority. When step S8 makes a positive determination, the processing proceeds to step S9 at which one of the communicable communication terminals, which is lowest in the communication cost, is selected. Further, the processing proceeds to step S16 at which the selected communication terminal performs communication.

When step S8 make a negative determination, the processing proceeds to step S10 at which it is determined whether the selected priority condition is the communication speed priority: When step S10 makes a positive determination, the processing proceeds to step S11 at which a communication terminal, which is highest in the communication speed, is selected. When step S10 make a negative determination, the processing proceeds to step S12 at which it is determined whether the selected priority condition is the self-vehicle area priority. When step S12 makes a positive determination, the processing proceeds to step S13 at which a selection is performed according to the self-vehicle position area.

The selection at step S13 is specified by the flowchart of FIG. 4. At step T1, it is determined whether the self-vehicle position is a home area. When it is determined that the self-vehicle position is a home area, step T1 makes a positive determination. In this case, the processing proceeds to step T2 at which the communication terminal 25 for home LAN, which is low in the communication cost in the home area, is selected. At step T2, the communication terminal 25 for home LAN is selected, since a communication cost of the communication terminal 25 for home LAN is, in general, lowest in a home area, compared with communication costs of other communication terminals.

When step T1 makes a negative determination, the processing proceeds to step T3, at which it is determined ,whether the self-vehicle is in a vehicle battery. charge facility area such as a convenience store. When step T3 makes a positive determination, the communication terminal 26 for PLC, which is wired and high in the communication stability, is selected. Alternatively, when step T3 makes a negative determination, the processing proceeds to step T5, at which it is determined whether the self-vehicle is in a city area. When step T5 makes a positive determination, the processing proceeds to step T6, at which a communication terminal, which is low in the communication cost, is selected. As follows, the reason why a communication terminal being low in the communication cost is selected will be described. In a city area, various kinds of communication infrastructures such as a wireless LAN (public wireless LAN), a PHS network, a cell-phone network, and the like are on service, in general. In addition, such communication infrastructures are high in the communication speed and the communication stability in many cases. Therefore, in such an environment with an excellent communication infrastructure, it may be desirable to give a priority to a communication infrastructure, which is low in the communication cost, or a free communication infrastructure.

When step T5 makes a negative determination, the processing proceeds to step T7, at which it is determined whether the self-vehicle is in a suburban area. When step T7 makes a positive determination, a communication terminal, which is high in the communication stability, is selected. Specifically, in a suburban area, an electric wave tends to be interrupted. Therefore, when the self-vehicle is in a suburban area, a communication terminal such as the communication terminal 22 for 1XWIN and the communication terminal 23 for HSDPA, which is high in the communication stability, may be suitable. The processing proceeds to step T16 in FIG. 3 subsequent to step T2, step T4, step T6, and step T8.

When step S12 make a negative determination, the processing proceeds to step S14 at which it is determined whether the selected priority condition is the communication stability priority. When step S14 makes a positive determination, the processing proceeds to step S15 at which a communication terminal, which is highest in the communication stability, is selected. Thus, the processing proceeds to step S16 at which communication is performed.

According to the present embodiment, priority conditions are assigned to multiple communication terminals 20 to 26 by using the operation switch group 9 and the remote controller 19. When multiple communication terminals, which are communicable, are detected, the communication control unit 27 selects a communication unit according to the assigned priority conditions, and causes the selected communication unit to communicate with the information center 32. Therefore, a communication terminal suitable for the assigned priority condition can be selected among multiple communication terminals, which are detected to be communicable. The operation switch group 9 and the remote controller 19 are equivalent to a priority condition assigning unit. The communication control unit 27 is equivalent to a communication unit selecting unit (selecting unit). The information center 32 is equivalent to an external resource center. For example, when an assigned priority condition is the communication cost priority, a communication terminal, which is low in the communication cost, can be selected from the multiple communication terminals. Alternatively, for example, when an assigned priority condition is the communication speed priority, a communication terminal, which is high in the communication speed, can be selected from the multiple communication terminals. In this way, an optimal communication terminal, which is suited to the assigned priority condition, can be selected. Thus, a map update data, music data and the like can be obtained from the information center 32 via the selected optimal communication terminal.

In particular, according to the present embodiment, the priority conditions to be assigned include at least two of the communication cost priority, the communication speed priority, the self-vehicle area priority, and the communication stability priority. When the priority condition of the communication cost priority is assigned, the communication control unit 27 selects the communication terminal, which is the lowest in- the communication cost, from the multiple communication terminals detected to be communicable. When the priority condition of the communication speed priority is assigned, the communication control unit 27 selects the communication terminal, which is the highest in the communication speed, from the multiple communication terminals detected to be communicable. When the priority condition of the self-vehicle area priority is assigned, the communication control unit 27 selects the communication terminal, which is beforehand assigned correspondingly to the self-vehicle position area of the self-vehicle, from the multiple communication terminals detected to be communicable, according to the self-vehicle position area. When the priority condition of the communication stability priority is assigned, the communication control unit 27 selects the communication terminal, which is the highest in the communication stability, from the multiple communication terminals detected to be communicable.

In this way, when the priority condition of the communication cost priority is assigned, the communication terminal, which is the lowest in the communication cost, can be selected from the multiple communication terminals detected to be communicable. Thereby, the communication cost can be reduced. Further, when the priority condition of the communication speed priority is assigned, the communication terminal, which is the highest in the communication speed, can be selected from the multiple communication terminals detected to be communicable. Thereby, data can be quickly obtained. Further, when the priority condition of the self-vehicle area priority is assigned, the optimal communication terminal, which is suitable for the self-vehicle position area of the self-vehicle, can be selected. Alternatively, when the priority condition of the communication stability priority is assigned, the communication terminal, which is the highest in the communication stability, can be selected from the multiple communication terminals detected to be communicable. Thereby, data can be steadily obtained.

The in-vehicle data communication device is used for an electric vehicle in the above-stated embodiment. It is noted that, the in-vehicle data communication device may be used for an automobile having an internal combustion engine, which uses liquid fuel such as gasoline or light oil. In the case, the communication terminal 26 for PLC may be omitted.

In the in-vehicle data communication unit according to the embodiment, a priority condition assigning unit is configured to assign priority conditions to communication units; a communication unit selecting unit is configured to, when the communicable unit detection unit detects multiple communication units communicable with the external resource center, select a communication unit according to the priority conditions assigned by the priority condition assigning unit. In this way, a communication unit, which is suitable for the assigned priority condition, can be selected from multiple communication units detected to be communicable. For example, when an assigned priority condition is the communication cost priority, a communication unit, which is low in the communication cost, can be selected from the multiple communication units. Alternatively, for example, when an assigned priority condition is the communication speed priority, a communication unit, which is high in the communication speed, can be selected from the multiple communication units. In this way, an optimal communication unit, which is suited to the assigned priority condition, can be selected. Thus, data can be obtained from an external information source via the selected optimal communication unit.

In the in-vehicle data communication unit according to the embodiment, the priority condition assigning unit is configured to assign the priority conditions including at least two of a communication cost priority, a communication speed priority, a self-vehicle area priority, and a communication stability priority. When the priority condition of the communication cost priority is assigned, the communication unit selecting unit selects, the communication unit, which is the lowest in the communication cost, from the multiple communication units detected to be communicable. When the priority condition of the communication speed priority is assigned, the communication unit selecting unit selects the communication unit, which is the highest in the communication speed, from the multiple communication units detected to be communicable. When the priority condition of the self-vehicle area priority is assigned, the communication unit selecting unit selects the communication unit, which is beforehand assigned correspondingly to the self-vehicle position area of the self-vehicle, from the multiple communication units detected to be communicable, according to the self-vehicle position area. When the priority condition of the communication stability priority is assigned, the communication unit selecting unit selects the communication unit, which is the highest in the communication stability, from the multiple communication units detected to be communicable.

In this way, when the priority condition of the communication cost priority is assigned, the communication unit, which is the lowest in the communication cost, can be selected from the multiple communication units detected to be communicable. Thereby, the communication cost can be reduced. Further, when the priority condition of the communication speed priority is assigned, the communication unit, which is the highest in the communication speed, can be selected from the multiple communication units detected to be communicable. Thereby, data can be quickly obtained. Further, when the priority condition of the self-vehicle area priority is assigned, the optimal communication unit, which is suitable for the self-vehicle position area of the self-vehicle, can be selected. Alternatively, when the priority condition of the communication stability priority is assigned, the communication unit, which is the highest in the communication stability, can be selected from the multiple communication units detected to be communicable. Thereby, data can be steadily obtained.

The above structures of the embodiments can be combined as appropriate.

The above processings such as calculations and determinations are not limited being executed by the control unit 10 and the communication control unit 27. The control unit may have various structures including the control unit 10 and the communication control unit 27 shown as an example.

The above processings such as calculations and determinations may be performed by any one or any combinations of software, an electric circuit, a mechanical device, and the like. The software may be stored in a storage medium, and may be transmitted via a transmission device such as a network device. The electric circuit may be an integrated circuit, and may be a discrete circuit such as a hardware logic configured with electric or electronic elements or the like. The elements producing the above processings may be discrete elements and may be partially or entirely integrated.

It should be appreciated that while the processes of the embodiments of the present invention have been described herein as including a specific sequence of steps, further alternative embodiments including various other sequences of these steps and/or additional steps not disclosed herein are intended to be within the steps of the present invention.

Various modifications and alternations may be diversely made to the above embodiments without departing from the spirit of the present invention.

What is claimed is:

1. An in-vehicle data communication unit communicable with an external resource center via a plurality of communication units, the in-vehicle data communication unit configured to select one of the communication units and obtain data from the external resource center via the selected one communication unit, the in-vehicle data communication unit comprising:
an assigning unit configured to assign priority conditions to the communication units;
a detection unit configured to detect which one of the communication units is communicable with the external resource center; and
a selecting unit configured to, when the detection unit detects a plurality of communication units to be communicable with the external resource center, select one communication unit from the communication units detected to be communicable, according to the priority conditions assigned by the assigning unit.

2. The in-vehicle data communication unit according to claim 1, wherein the assigning unit is configured to assign the priority conditions including at least two of a communication cost priority, a communication speed priority, a self-vehicle area priority, and a communication stability priority,
the selecting unit is further configured to:
select a communication unit, which is lowest in a communication cost, from the communication units detected to be communicable, when the assigning unit assigns the communication cost priority;
select a communication unit, which is highest in a communication speed, from the communication units detected to be communicable, when the assigning unit assigns the communication speed priority,
select a communication unit, which is beforehand assigned corresponding to a self-vehicle position area of a self-vehicle, from the communication units detected to be communicable, when the assigning unit assigns the self-vehicle area priority, and
select a communication unit, which is highest in a communication stability, from the communication units detected to be communicable, when the assigning unit assigns the communication stability priority.

3. A method for communicating with an external resource center, the method comprising:
assigning priority conditions to a plurality of communication units;
detecting which one of the communication units is communicable with the external resource center;
selecting, when the detecting detects a plurality of communication units to be communicable with the external resource center, one communication unit from the communication units detected to be communicable, according to the assigned priority conditions; and
obtaining data from the external resource center via the selected one communication unit.

4. A computer readable medium comprising instructions executed by a computer, the instructions including the method according to claim 3.
